(19) United States
(12) Patent Application Publication
(10) Pub. No.: US 2007/0019803 A1
(43) Pub. Date: Jan. 25, 2007

(54) Loudspeaker-microphone system with echo cancellation system and method for echo cancellation

(75) Inventors: Ivo Leon Diane Marie Merks, Eindhoven (NL); David Antoine Christian Marie Roovers, Eindhoven (NL); Alexander Stenger, Fuerth (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/558,087

(22) PCT Filed: May 18, 2004
(86) PCT No.: PCT/IB04/50723

§ 371 Date: Nov. 23, 2005

(30) Foreign Application Priority Data
May 27, 2003 (EP) 03101540.7

(51) Int. Cl. H04M 9/08

(52) U.S. Cl. 379/406.08

(57) ABSTRACT

A two way sound reproduction system, such as a mobile phone system has an input (2) for an incoming far end signal (W), a loudspeaker (5), a D-to-A-converter (3) between the input (2) and the loudspeaker (5), a microphone (7), a A-to-D (8) converter after the microphone (7), an echo cancellation system (AEC) and an output (12) for an outgoing far end signal. The system comprises a pre-processor (30) between the input (2) and the D-to-A converter (3) comprising: an amplifier (32) to amplify the signal to a sufficient sound pressure level, a clipper or compressor or limiter (33) to limit the signal in the digital domain, so that the telephone system between D-to-A converter (3) and A-to-D converter (8) behaves substantially like a linear system.

This invention relates to the field of sound reproduction, and more particularly to the suppression of echoes in systems comprising a loudspeaker and a microphone.

The invention relates to a two-way sound reproduction system (such as e.g. a handsfree loudspeaker telephone system) having an input for an incoming far end signal, a loudspeaker, a D-to-A-converter between input and loudspeaker, a microphone, an A-to-D converter after the microphone, an echo cancellation system (AEC) and an output for an outgoing far end signal.

The invention also relates to a method for echo canceling in a two-way sound reproduction system having a loudspeaker and a microphone, in which method:

a digital far end input signal is received or is generated from an analog far end input signal

the digital far end signal is converted into an analog signal,

the converted analog signal is emitted via the loudspeaker,

the microphone generates an analog microphone signal,

the analog microphone signal is converted into a digital microphone signal,

an echo cancellation is performed by filtering the digital far end signal and subtracting the result from the digital microphone signal.

A two-way sound reproduction system, such as e.g. a loudspeaker telephone system, includes an output transducer, often called a loudspeaker, and an input transducer, often called a microphone. The loudspeaker produces sound pressure waves in response to an input signal received from a distant party (an incoming far end signal) which is representative of a desired sound pressure wave, and the microphone receives sound pressure waves to be converted to an output signal and transmitted to the distant party via an output for an outgoing far end signal. Because the loudspeaker emits sound into the environment around the loudspeaker telephone, there is an acoustic path from the loudspeaker to the microphone which may result in an echo. Typically, this acoustic path includes a plurality of transmission paths (representing a plurality of reflections) so that a plurality of echoes reach the microphone at different times.

If nothing is done to compensate for this acoustic path, sound generated by the loudspeaker will echo back through the microphone to the distant user at the far end. In practice, this means that when the distant party speaks, his/her speech will be emitted by the loudspeaker and then transmitted back, making conversation difficult, since the distant party hears his/her own voice as well as the voice of the party he/she is communicating with. Accordingly, there have been attempts in the art to reduce these echoes.

One way to reduce undesired echoes is to use a so-called echo canceling system to suppress echo, in which echo canceling system a replica of the undesired component (the echo) is derived from the far end signal by means of an adaptive filter. Said replica is subtracted from the output signal, in order to eliminate the undesired echo.

Most echo cancellation systems in today's telephones are based on the assumption of a linear echo path. It has been recognized that the echo comprises also non-linear components, and such non-linear components may be difficult to compensate.

In United States Patent U.S. Pat. No. 5,680,450 a model is presented to compensate for non-linear portions of the echo as well as device and methods based on such model.

In Proceedings of the ICASSP (International Conference on Acoustics, Speech and Signal Processing) 2000, vol. 11, page 805-808, Jun. 5-9 2000 by Stenger, an AEC (Adaptive Echo Canceller) is described in which a non-linear model (7-th order polynomial) is used for echo cancellation.

These known systems and models are based on estimating the echo signal, including any non-linear components corresponding to non-linear portions of the echo. Therefore, when the estimated echo signal is subtracted from the output signal generated by the microphone, non-linear portions of the echo generated by the loudspeaker can be reduced. The adaptive echo filter thus includes estimates of non-linear components, often based on an acoustic path model which generates an estimate of the acoustic path from the loudspeaker to the microphone.

Notwithstanding the above-mentioned references, there continues to exist a need in the art for improved loudspeaker telephone systems and methods which reduce echoes from the loudspeaker to the microphone.

It is an object of the present invention to provide a two-way sound reproduction system with improved echo cancellation and methods for echo cancellation for two-way sound reproduction systems.

To this end, the two-way sound reproduction system in accordance with the invention is characterized in that the system comprises a pre-processor for preprocessing an incoming far end signal, the pre-processor comprising an amplifier for amplification of the incoming far end signal, and a means for limiting the maximum amplitude of the far end signal, wherein the limited signal is an input for the loudspeaker and the echo canceling system.

The means for limiting is e.g. a clipper, a limiter or a compressor, or a combination of those.

The invention is based on the following insight:

Two-way sound reproduction systems, especially loudspeaker telephone systems, often need a large dynamic range. Especially when a mobile telephone is used in handsfree mode, it has to produce a high sound level, well above sound levels ordinarily used when the phone is held against the ear. In order to achieve this high sound level, the audio signal is conventionally greatly amplified, for instance by an analogue power amplifier, which is conventionally placed just before the loudspeaker. In fact the audio signal is amplified to such an extent, that the audio signal is heavily clipped by the voltage supply of the telephone system (e.g. a mobile phone). This results in a very non-linearly distorted loudspeaker signal which is picked up by the microphone of the telephone system as an echo. The non-linear behavior of the amplifier is generally the most significant source of non-linearities.

The echo can be reduced by an echo cancellation system in the two-way sound reproduction system, e.g. in the mobile phone. However, the echo cancellation is conventionally based on the assumption that the mobile phone (i.e. amplifier, loudspeaker, housing, microphone) can be seen as a linear system with respect to the echo. Hence, the echo cancellation system is not able to cancel non-linearly distorted echo.

As mentioned above it has been described to compensate for non-linear components in the echo path. To this end, the adaptive filter must be extended to include non-linear components. However, modeling such system is a very difficult task only possible when there is a good model available for these non-linearities. However, there is no generic non-linear model for all mobile phones. Furthermore, non-linear models contain often a lot of coefficients and therefore the adaptation is very difficult and costs a lot of memory and computation power.

This invention proposes to preprocess the audio signal in the digital domain, i.e. in front of the digital to analog conversion as well as in front of the echo canceller, such that the part of the system between the D-to-A converter and the A-to-D converter is a linear system or nearly linear system and such that the loudspeaker produces enough sound pressure level.

In the two-way sound reproduction system in accordance with the invention, the system comprises a pre-processor comprising:

an amplifier to amplify the audio signal to a sufficient Sound Pressure Level

a clipper/compressor/limiter function to limit the audio signal in the digital domain, so that the mobile phone behaves substantially like a linear system.

The two-way sound reproduction system in accordance with the invention comprises an echo canceling system. The difference with known systems lies in the addition of a pre-processor which comprises a means for limiting the audio signal to a level in which the non-linear components are relatively small.

A disadvantage of the invention is that the sound level is reduced somewhat, since the loudspeaker signal is reduced. However, this disadvantage is small compared to the advantage of improved echo cancellation.

In preferred embodiments the pre-processor comprises a high-pass filter.

Preferably the cut-off value for the high-pass filter lies in the range of 100-1000 Hz, most preferably between 300-500 Hz.

In embodiments of the invention the means for limiting comprises a clipper for clipping the far end signal above a signal strength.

Clipping is a simple operation in which any signal above a threshold signal strength is reduced to said given threshold signal strength, i.e. a maximum signal strength is set. The advantage of such an embodiment is that a simple device is used, the disadvantage is that the far end signal is distorted, since any details in the signal above the threshold signal are lost.

In preferred embodiments the means for limiting comprises a limiter or compressor to limit the maximum amplitude of the signal to the loudspeaker. In these embodiments the maximum amplitude of the signal is limited or the dynamic range compressed.

A limiter scans for peaks in the audio signal and attenuate the audio portion around the peak if the attenuation is necessary to prevent clipping.

A compressor reduces the overall dynamic range of any audio signal. It consists of two elements: a level detector and an amplifier with variable gain. Compared to a clipper there is less distortion, but a more complex design.

In embodiments the means for limiting may comprise both a clipper and a limiter/compressor and a means for switching from the one function to the other.

The method in accordance with the invention is characterized in that prior to the digital to analog conversion and the echo cancellation the digital far end signal is amplified and limited.

Within the concept of the invention a ‘clipper’, compressor’, ‘limiter’, ‘filter’, ‘converter’, comparator’ etc are to be broadly understood and to comprise e.g. any piece of hard-ware (such a converter, compressor, limiter etc), any circuit or sub-circuit designed for performing a conversion, compression, filtering etc function as described as well as any piece of soft-ware (computer program or sub program or set of computer programs, or program code(s)) designed or programmed to perform a conversion, clipping, limiting, filtering etc operation in accordance with the invention as well as any combination of pieces of hardware and software acting as such, alone or in combination, without being restricted to the below given exemplary embodiments. One program may combine several functions.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in a telephone system in accordance with the invention, for performing the action specific for the invention.

These and further aspects of the invention will be explained in greater detail by way of example and with reference to the accompanying drawings, in which

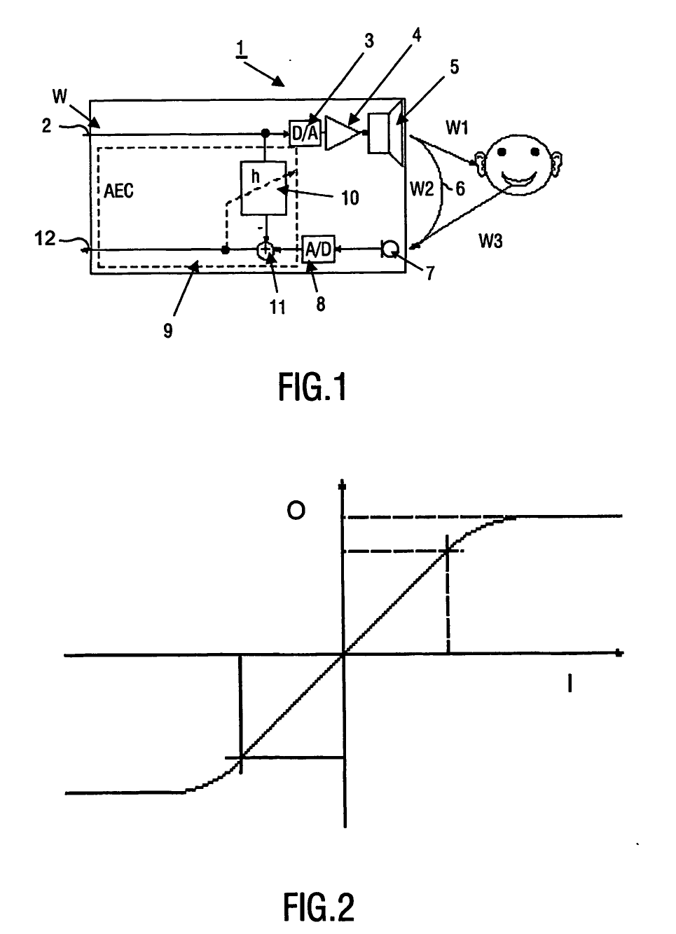

FIG. 1 is a schematic diagram of a loudspeaker telephone system including a loudspeaker, a microphone, and an echo canceling system according to the prior art.

FIG. 2 shows a typical saturation curve for an amplifier.

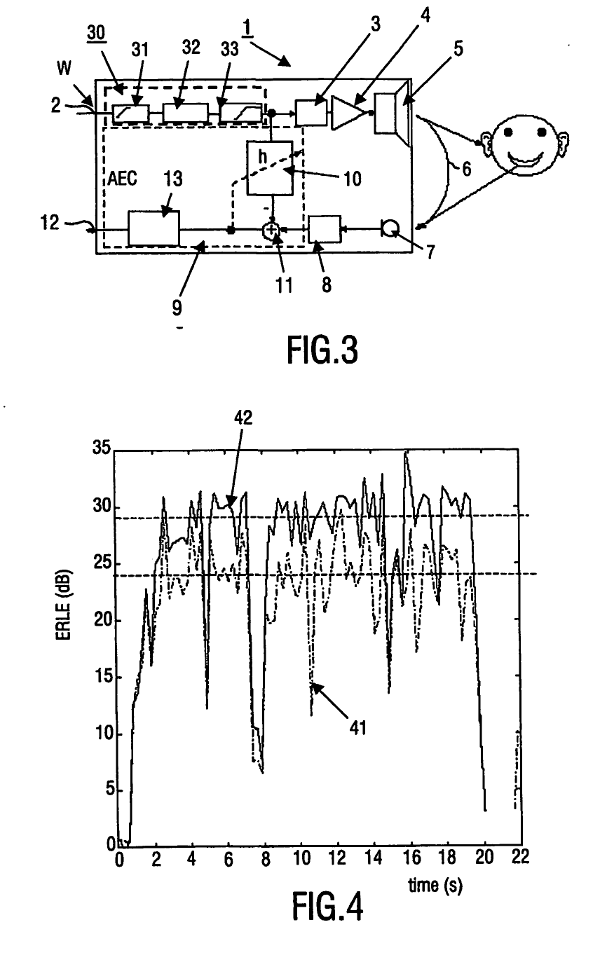

FIG. 3 is a schematic diagram of a loudspeaker telephone system including a loudspeaker, a microphone, and an echo canceling system and a pre-processor in accordance with the invention.

FIG. 4 illustrates in a graphical form an example effect of the addition of the pre-processor.

The present invention will now be described more fully hereinafter with reference to the accompanying drawings, in which preferred embodiments of the present invention are shown. This invention may, however, be embodied in many different forms and should not be construed as limited to the embodiment set forth herein; rather, these embodiments are provided so that this disclosure will be thorough and complete, and will fully convey the scope of the invention to those skilled in the art. Like numbers refer to like elements throughout.

FIG. 1 illustrates schematically a telephone system from the prior art. Such system can for instance be a hands-free loudspeaker cellular radiotelephone for use in an automobile. When implemented as a hands-free cellular telephone, speech signals received from a far end, i.e. from a distant party, are transmitted from a cellular base station (not shown), received by the transceiver of the cellular phone (not shown), and applied to the input 2 for an incoming far end signal as an input waveform W. In this example it is assumed that the transmission back and forth between the system, in this example a telephone system, and the far end is in a digital form. If the original signals are in an analog form the system comprises an A-to-D converter to generate an analog far end signal which is then fed into input 2.

As shown in FIG. 1, the waveform is applied in a digital format at input 2, and converted to an analog format by D-to-A converter 3 and amplified by amplifier 4 for use by the loudspeaker 5. A sound pressure wave W1 representative of the speech of the distant party is emitted by loudspeaker 5. Accordingly, the radiotelephone user hears sound pressure waveforms which are representative of the speech of the distant party.

The sound, however, is also emitted along the acoustic path 6 which can include multiple channels. As a result, echoes W2 are received by an input transducer such as microphone 7. It is therefore desirable to reduce these echoes in the output signal generated by the microphone 7 so that the distant party is not confused by delayed echoes of his own speech, in other words to ensure that the signal sent to the far end is representative of the signal W3, the speech of the other party and not some mix of signals W3 and W2. The mixed signal is received by microphone 7, and converted into a digital signal by A-to-D converter 8. This echo reduction is achieved by using an adaptive echo canceller (“AEC”) 9. The adaptive echo canceller comprises an adaptive filter 10, into which incoming signal 2 is fed and filtered. The filtering coefficient being adaptive, the adaptive filter 10 provides for an estimated echo signal, and this estimated echo signal is subtracted from the signal coming from microphone 7 (after A/D conversion in A/D converter 8) in subtractor 11. The end result is, ideally, that the echo signal is subtracted from the signal received by the microphone so that only a signal representative of speech W3 leaves output 12. The coefficients of the adaptive filter 10 are an estimate of the acoustical impulse response. The adaptive filter may be implemented with several algorithms: Normalized Least Mean Squares (NLMS), Frequency Domain Adaptive Filter (FDAF). The choice of adaptive filter depends on the application, available resources, and user preference.

Depending on the model used for the acoustical path the estimated echo signal can approximate the echo from the loudspeaker received by the microphone.

Adaptive filters used in echo cancellation are discussed in the mentioned prior art. Further examples of different adaptive filter are mentioned in the cited prior art.

However, although many different models exists for echo cancellation in practice the balance between complexity of the system (adding to the costs) and the effects of echo cancellation is far from optimal.

As mentioned above it has been described to compensate for non-linear components in the echo path. To this end, the adaptive filter must be extended to include non-linear components.

In general, the known systems and methods have one main problem: they require a good model of the non-linearities in the system. Extending the adaptive filter 10 with a non-linear adaptive filter is only possible when there is a good model available for these non-linearities. However, there is no generic non-linear model for all mobile phones. Furthermore, non-linear models contain often a lot of coefficients and therefore the adaptation is very difficult and costs a lot of memory and computation power. If there is no good model available, the attenuation will be insufficient.

The analog amplifier used to generate the loudspeaker signal can be modeled in three parts:

1. Generally, the amplifier contains a high-pass filter. Sometimes, this filter only removes DC-offset. In many cases, however, the filter also removes the low frequencies of the far-end signal which cannot be reproduced by the loudspeaker.

2. The actual amplification of the far-end signal can be modeled as a simple linear gain.

3. At high output levels, the output level is saturated by the limited voltage supply. A typical saturation curve is presented in FIG. 2. It shows that the output O is a function of the input I. In the linear range, indicated in the figure by the corners of the rectangles, the output O is a linear function of I, i.e. O=a*I. Outside the linear range, the output level is limited by the limited voltage supply and non-linearities occur and the output O is a more complex function of the input I.

However, the model of the amplifier, as presented above, shows that we are dealing with a cascade of a linear system (1 and 2), a non-linear system (3) and an almost linear system (the loudspeaker and the acoustic path). Modeling such system is a very difficult task.

This invention proposes to preprocess the audio signal in the digital domain, i.e. in front of the digital to analog conversion as well as in front the echo canceller, such that the mobile phone is a linear system or nearly linear system again and such that the loudspeaker produces enough sound pressure level.

To prevent saturation of the amplifier output signal (i.e. loudspeaker signal) by the limited voltage supply, the input signal should be restricted not to exceed a certain limit. This voltage limit can be deduced from the saturation curve in FIG. 2.

However, if an analog high-pass filter is present in front of the amplifier, a further restriction may be needed. This is due to the fact that filtering a voltage-limited signal may result in an output signal exceeding the voltage limit. This effect is known as the Gibb effect.

The analog high-pass filter can be assume to be a first order RC network. It is known that the amplitude amplification of such a filter is always less or equal to 2 for arbitrary input signals. The reason for this is that the so-called L1-norm of the filter's impulse response equals 2. As a result, to prevent any saturation of the amplifier output signal, the input signal of the high-pass filter should be restricted to half the voltage limit as shown in FIG. 2.

In practice, to find a trade-off between sufficient sound pressure level and acceptable non-linearities, the input voltage should be limited to a value between 0.5 and 1.0 times the voltage limit as shown in FIG. 2.

Since, the far-end speech signal usually has strong low-pass characteristic, the saturation in the analog amplifier is largely due to low frequency signal components. To prevent this saturation, heavy clipping is needed in the digital domain leading to audible non-linear distortion. However, these low frequencies cannot be reproduced by the loudspeaker. So it is better to remove, these low frequency components by applying a digital high-pass filter before the digital clipping. Its frequency response is preferably chosen to correspond to the frequency response of the loudspeaker,

Since the cut-off frequency of the analog high-pass filter will generally be lower, the digital high-pass filter leads to a reduction of the frequency components around the cut-off frequency of the analog HP filter. This results in a reduction of the Gibb phenomenon.

Thus, the two-way sound reproduction system in accordance with the invention, the telephone system comprises a pre-processor comprising:

(optionally) a high-pass filter to attenuate the low-frequencies which cannot be properly reproduced by the loudspeaker.

an amplifier to amplify the audio signal to a sufficient Sound Pressure Level

a clipper/limiter/limiter function to limit the audio signal in the digital domain, so that the mobile phone behaves substantially like a linear system, i.e. limit the output O to the linear range.

Note that there is a remarkable similarity between the preprocessor and the analogue power amplifier. The digital clipper/limiter/limiter function reduces the effect of the saturation in the analogue power amplifier. Likewise, the digital high-pass filter reduces the effect of the analogue high-pass filter. The result is that the analogue power amplifier operates substantially as a linear system. Thus the problems of the prior art device and method are reduced.

The invention offers a better balance by the addition of a preprocessor of the far-end signal to the Acoustic Echo Canceller, such that the mobile phone (from D/A- to A/D-converter) is a linear system again. As explained, the linearity of the analog system is very important for a good and reliable Acoustic Echo Cancellation.

FIG. 3 illustrates a loudspeaker telephone system in accordance with the invention. The loudspeaker telephone system comprises a pre-processor 30, comprising in this example the following:

1. A high pass filter 31. This is an optional and preferred part of the pre-processor.

2. A gain 32 to amplify the far-end signal to a sufficient level.

3. A clipper/limiter/compressor 33 to limit the maximum amplitude of the far-end signal, such that the telephone system is substantially a linear system again.

In this example the order of the elements is 1, 2, 3. However this is not a restriction. The order of the three steps can be varied. Other possible orders are:

2, 1, 3

1, 3, 2

The sequence of the high-pass filter and clipping/limiting/compression function cannot be changed, because applying a high-pass filter after clipping/limiting/compression function will still result in a signal with amplitudes above the desired level. These amplitudes are signal-dependent and they can therefore not be corrected for.

The shown exemplary telephone system comprises, within the AEC a processor 13. This is shown in this example, since it is explicitly remarked that, although the invention offers the possibility to linearize the system, it is not excluded that some post processing may be done.

A way to measure the non-linearities in the signal is the following. A noise signal is played at maximum level through the loudspeaker and a long and slowly adapting adaptive filter is running to cancel the echo. After convergence, the level of residual echo is a measure for the non-linearities of the signal and this level is usually given with respect to the echo level. If the residual echo is 30 dB below the echo, then the non-linearities are said to be at −30 dB.

Within the concept of the invention the non-linearities in the analog system are usually at least −20 dB (w.r.t to the linear signal), but preferably at −30/−35 dB. It is not needed to reduce the non-linearities to below −40 dB, because the noise in the near-end room is in that case the largest interference for the Acoustic Echo Canceller.

FIG. 4 shows the effect of the pre-processor. The curve 41 shows the echo canceling without the pre-processor, curve 42 with pre-processor, on average an additional echo cancellation of some 5-6 dB extra is obtained, which is clearly an audible effect.

As far as the elements of the pre-processor are concerned the following is remarked:

High-Pass Filter 31:

The choice of the high-pass filter depends on the loudspeaker and the far-end signal. In handsfree communication with mobile devices, the signal is speech, which contains considerable low frequency components, and the loudspeaker is small, which means it cannot reproduce low frequencies. Their size determines the cut-off frequency, which lies between 100 and 1000 Hz, preferably between 300 and 1000 Hz, even more preferably between 300 and 500 Hz. The high-pass filter is part of the preferred design enabling to make the analog part of the system sufficiently linear. The choice of the high-pass filter also preferably depends on the presence and cut-off frequency of an analog high-pass filter in the loudspeaker amplifier. If such an analog high-pass filter is present, the cut-off frequency of the digital high-pass filter is above, preferably considerably above that of its analog counterpart.

The high-pass filter can be implemented in several ways such as Finite Impulse Response (FIR) or Infinite Impulse Response filter.

Gain 32:

The gain is preferably a simple straightforward gain to amplify the far-end signal x to a sufficient level. The gain function is: y=Ax, where A is the amplification factor. This function is preferably combined with the clipping/limiting/compression function.

Clipping/Limiting/Compression Function 33:

The clipping/limiting/compression function limits the amplitude of the far end signal such that the mobile phone is a linear system again. Implementation of this function can be done in more than one way. An ordinary clipping function may in some embodiment be used. Prima facie one would think that playing a clipped signal on a ordinary loudspeaker sounds horrible, which in fact is true, but playing a clipped signal on a handsfree mobile does not sound more horrible than more advanced methods, because the quality of the reproduction of a handsfree mobile is rather poor. Furthermore, the level of the sound is much more important than the quality of the sound. More advanced clipping/limiting/compression function may be used in preferred embodiments, is useful in view of the reproduction capabilities of a mobile. The function may also comprise both a clipper as well as a limiter/compressor.

It is remarked that the use of a clipping function (or clipper) in the pre-processor 30 as in the telephone system in accordance with the invention for the far-end signal before it is sent to the loudspeaker and the filter should not be confused with the use of a center clipper in a post-processor in the AEC filter. Use of a such functions in post-processors may still be useful, since due to the use of the far-end pre-processor 30, the linearity of the system has to be measured again to make sure that it is sufficient linear. The high-pass filter and clipping function introduces heavy (linear as well as non-linear) distortion in the far-end signal. This may seem contradictionary, on the one hand the system is more linear, while on the other hand the signal is less linear. The explanation is as follows:

By clipping the signal to the loudspeaker amplifier (i.e. preprocessing the signal), the signal to the loudspeaker amplifier is held below saturation values, and the loudspeaker amplifier is always operated in the linear region, i.e. it is not driven into saturation. Consequently, the amplifier operates linearly, and the echo of the signal produced by the loudspeaker (and that is what is compensated for in and by the AEC) does not comprise or at least only to a small degrees non-linear components, i.e. components that are non-linear in respect of the signal going into the loudspeaker amplifier. Consequently, echo cancellation is relatively simple and a simple AEC may be used. A considerable reduction of echo is obtained. However, compared to the far end signal, the pre-processor does introduce heavy distortion. To put it simply, there is a reduction of the quality of the sound produced by the loudspeaker. For Hifi-application, this is unacceptable, but for mobile devices, which have limited reproduction, it does not make a big difference. Compared to other deficiencies in the reproduced sound, echo is a particularly bothersome effect. The small effect in reproduction quality in many systems, especially in mobile telephone systems, is less than the positive effect of a reduction of echo.

To put it simply: the far-end pre-processor 30 introduces (non-)linear distortion, but the system is linear from D/A- to A/D-converter, i.e. the non-linearity is known to the adaptive filter. Because the far-end preprocessor is put before the input of the adaptive filter, the adaptive filter only has to model a linear echo and it can therefore achieve good echo cancellation. The positive effect of this echo cancellation is larger than the negative effect of non-linear distortions.

The invention may be used in various devices. The invention is in particular useful for handsfree Acoustic Echo Cancellers on mobile phones. However, it is applicable for all AEC'S, which run on a device with a limited voltage supply and/or small loudspeaker. A list of possible applications:

handsets (mobile, DECT, etc.);

handsfree terminals

PDA'S;

car-kits

Tv's with voice control or communication; computers, laptops;

web-terminals with voice control or communication;

answering machines;

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The present invention has been described in terms of specific embodiments, which are illustrative of the invention and not to be construed as limiting. The invention may be implemented in hardware, firmware or software, or in a combination of them. Other embodiments are within the scope of the following claims.

In short the invention can be described as follows: A two way sound reproduction system, such as a mobile phone system has an input (2) for an incoming far end signal (W), a loudspeaker (5), a D-to-A-converter (3) between the input (2) and the loudspeaker (5), a microphone (7), a A-to-D (8) converter after the microphone (7), an echo cancellation system (AEC) and an output (12) for an outgoing far end signal. The system comprises a pre-processor (30) between the input (2) and the D-to-A converter (3) comprising:

an amplifier (32) to amplify the signal to a sufficient sound pressure level

a clipper or compressor or limiter (33) to limit the signal in the digital domain, so that the system between D-to-A converter (3) and A-to-D converter (8) behaves substantially like a linear system.

Many variations are possible within the concept of the invention. The invention is e.g. also embodied in a device for a two way sound reproduction system having an input (2) for an incoming far end signal (W), an output for a loudspeaker, a D-to-A-converter (3) between the input (2) and output for the loudspeaker (5), an input for a microphone (7), a A-to-D (8) converter after the input for the microphone (7), an echo cancellation system (AEC) and an output (12) for an outgoing far end signal, characterized in that the device comprises the input (2) for an incoming far end signal (W), the echo cancellation system (AEC), the output (12) for an outgoing far end signal and a pre-processor (30) between the input (2) and the D-to-A converter (3) comprising an amplifier (32) for amplification of the incoming far end signal, and a means for limiting (33) the maximum amplitude of the far end signal, wherein the limited signal is an input for the loudspeaker and the echo canceling system.

For instance in a mobile phone system, the pre-processor and the AEC may be incorporated in the mobile phone, whereas the microphone and loudspeaker are incorporated in the stand of a hands-free kit for the mobile phone. In FIG. 3 this possibility is schematically indicated by the dotted line, these dotted lines could also be drawn before the D/A and A/D converters, depending the item in which these converters are incorporated. This example is shown to make it clear that the pre-processor and AEC may, within the broadest concept of the invention, be provided, in case the system comprises a number of physical separate and separately sold items, e.g. plug-in cards for a mobile phone, in one of the separate items, such as for instance when a hands-free kit-mobile phone system is considered in the mobile phone or in the hands-free kit.

Although the invention is most useful in mobile telephone system the system is, within the broadest concept of the invention not restricted to such system and the far end signals need not necessarily be telephone signals.

1. A two way sound reproduction system having an input (2) for an incoming far end signal (W), a loudspeaker (5), a D-to-A-converter (3) between the input (2) and the loudspeaker (5), a microphone (7), an A-to-D (8) converter after the microphone (7), an echo cancellation system (AEC) and an output (12) for an outgoing far end signal and, characterized in that the system comprises a pre-processor (30) between the input (2) and the D-to-A converter (3) comprising an amplifier (32) for amplification of the incoming far end signal, and a means for limiting (33) the maximum amplitude of the far end signal, wherein the limited signal is an input for the loudspeaker and the echo canceling system.

2. A two way sound reproduction system as claimed in claim 1, characterized in that the pre-processor further comprises a high-pass filter (31) to attenuate the low-frequencies of the far end signal (W).

3. A two-way sound reproduction system as claimed in claim 3, characterized in that the cut-off frequency of the high-pass filter (31) lies between 100 and 1000 Hz, preferably between 300 and 1000 Hz.

4. A two-way sound reproduction system as claimed in claim 1, characterized in that the means for limiting (33) comprises a clipper for clipping the far end signal above a signal strength.

5. A two-way sound reproduction system as claimed in claim 1, characterized in that the means for limiting (33) comprises a limiter or compressor to limit the maximum amplitude of the signal to the loudspeaker.

6. A two-way sound reproduction system as claimed in claim 1, characterized in that the two-way sound reproduction system is a loudspeaker telephone system.

7. A two-way sound reproduction system as claimed in claim 6, characterized in that the loudspeaker telephone system is a mobile telephone system.

8. A two way sound reproduction system as claimed in claim 1, characterized in that the two-way reproduction system is any one of the group of handsets (mobile, DECT, etc.), handsfree terminals, PDA'S, car-kits, TV's with voice control or communication, computers, web-terminals with voice control or communication, answering machines.

9. A device for a two way sound reproduction system having an input (2) for an incoming far end signal (W), an output for a loudspeaker, a D-to-A-converter (3) between the input (2) and output for the loudspeaker (5), an input for a microphone (7), a A-to-D (8) converter after the input for the microphone (7), an echo cancellation system (AEC) and an output (12) for an outgoing far end signal, characterized in that the device comprises the input (2) for an incoming far end signal (W), the echo cancellation system (AEC), the output (12) for an outgoing far end signal and a pre-processor (30) between the input (2) and the D-to-A converter (3) comprising an amplifier (32) for amplification of the incoming far end signal, and a means for limiting (33) the maximum amplitude of the far end signal, wherein the limited signal is an input for the loudspeaker and the echo canceling system.

10. A method for echo canceling in a two way sound reproduction system having a loudspeaker and a microphone, in which method:
a digital far end input signal is received or is generated from an analog far end input signal
the digital far end signal is converted into an analog signal,
the converted analog signal is emitted via the loudspeaker,
the microphone generates an analog microphone signal,
the analog microphone signal is converted into a digital microphone signal,
an echo cancellation is performed by filtering the digital far end signal and subtracting the result from the digital microphone signal, characterized in that prior to the digital to analog conversion and the echo cancellation the digital far end signal is amplified and limited below a limiting value.

11. A method as claimed in claim 10, characterized in that the digital far end signal is clipped.

12. Computer program comprising program code means for performing a method as claimed in claim 10 when said program is run on a computer.

13. Computer program product comprising program code means stored on a computer readable medium for performing a method as claimed in claim 10.
